(19) United States
(12) Patent Application Publication
(10) Pub. No.: US 2023/0223624 A1
(43) Pub. Date: Jul. 13, 2023

(54) SECONDARY BATTERY

(71) Applicant: MURATA MANUFACTURING CO., LTD., Kyoto (JP)

(72) Inventor: Kunio SODEYAMA, Kyoto (JP)

(21) Appl. No.: 18/124,881

(22) Filed: Mar. 22, 2023

Related U.S. Application Data
(63) Continuation of application No. PCT/JP2021/033278, filed on Sep. 10, 2021.

(30) Foreign Application Priority Data
Oct. 15, 2020 (JP) 2020-173645

(51) Int. Cl. H01M 50/159; H01M 50/107; H01M 10/0525

(52) U.S. Cl. CPC H01M 50/159; H01M 50/107; H01M 10/0525

(57) ABSTRACT

A secondary battery includes a battery can and a cover member. The battery can has a container-shaped structure and contains a battery device inside. The cover member is attached to an open surface of the battery can via a gasket. The cover member includes stainless steel coated with nickel plating. The nickel plating has a crystal structure in which a proportion of columnar crystals is greater than or equal to 80%.

### CROSS REFERENCE TO RELATED APPLICATIONS

The present application is a continuation of PCT patent application no. PCT/JP2021/033278, filed on Sep. 10, 2021, which claims priority to Japanese patent application no. 2020-173645, filed on Oct. 15, 2020, the entire contents of which are incorporated herein by reference.

### BACKGROUND

The present application relates to a secondary battery.

In recent years, various kinds of electronic equipment, including mobile phones, have been widely used. Such widespread use has promoted development of a secondary battery as a power source that is smaller in size and lighter in weight and allows for a higher energy density. Influencing a battery characteristic, each configuration in the secondary battery has been considered in various ways.

### SUMMARY

The present application relates to a secondary battery.

Such a secondary battery has a high energy density, and is used for a long time. It is thus desirable that the secondary battery have higher reliability.

It is therefore desirable to provide a secondary battery with further improved reliability.

A secondary battery according to an embodiment of the present technology includes a battery can and a cover member. The battery can has a container-shaped structure and contains a battery device inside. The cover member is attached to an open surface of the battery can via a gasket. The cover member includes stainless steel coated with nickel plating. The nickel plating has a crystal structure in which a proportion of columnar crystals is greater than or equal to 80%.

According to the secondary battery of an embodiment of the present technology, the cover member attached to the battery can containing the battery device inside includes the stainless steel coated with the nickel plating including columnar crystals in a proportion of greater than or equal to 80%. Thus, in the secondary battery, it is possible to further increase a peel strength of the nickel plating in the cover member, and to further increase a joint strength achieved by welding to the cover member. This makes it possible to further increase a joint strength achieved by coupling a wiring line to the cover member, which allows the secondary battery to obtain higher reliability.

Note that effects of the present technology are not necessarily limited to those described herein and may include any of a series of suitable effects in relation to the present technology.

### BRIEF DESCRIPTION OF THE FIGURES

FIG. 1 is a sectional view of a configuration of a lithium-ion secondary battery (a cylindrical type) according to an embodiment of the present technology.

FIG. 2 is an enlarged sectional view of a configuration of a main part of the lithium-ion secondary battery illustrated in FIG. 1.

FIG. 3 is an enlarged sectional view of the vicinity of a cover member of the lithium-ion secondary battery illustrated in FIG. 1.

FIG. 4 is a top view of a planar configuration of the cover member.

FIG. 5 is a schematic sectional view of a crystal structure of a plating layer included in the cover member.

FIG. 6 is a block diagram illustrating a configuration of a battery pack that is an example of an application example of the secondary battery.

### DETAILED DESCRIPTION

One or more embodiments of the present technology are described below in further detail including with reference to the drawings.

A description is given of a secondary battery according to an embodiment of the present technology.

The secondary battery to be described here is a secondary battery that obtains a battery capacity using insertion and extraction of an electrode reactant, and includes a positive electrode, a negative electrode, and an electrolytic solution. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is greater than an electrochemical capacity per unit area of the positive electrode.

Although not particularly limited, the electrode reactant is a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

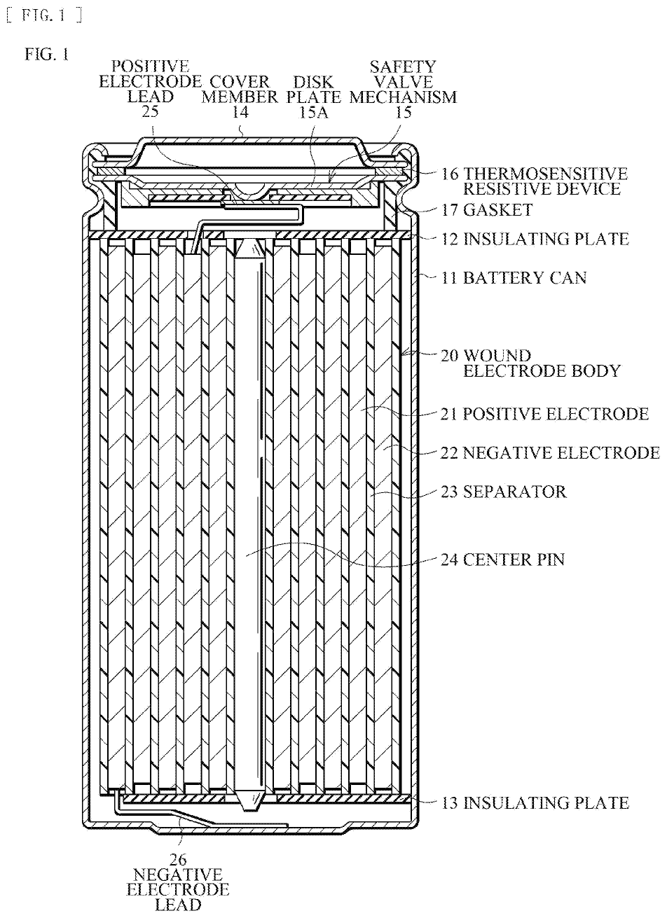

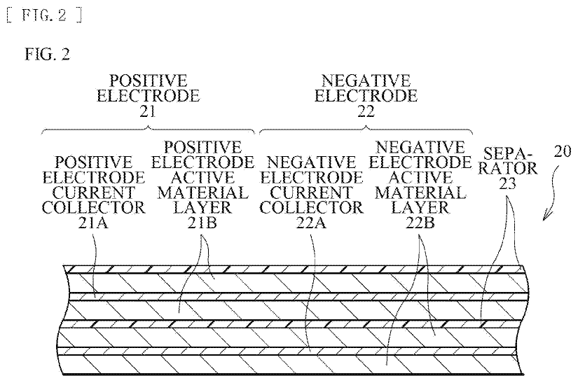

FIG. 1 is a sectional diagram illustrating a sectional configuration of the secondary battery. FIG. 2 is a sectional diagram illustrating, in an enlarged manner, a sectional configuration of a main part (a wound electrode body 20) of the secondary battery illustrated in FIG. 1. Note that FIG. 2 illustrates only a portion of the wound electrode body 20.

The secondary battery illustrated in FIG. 1 is a lithium-ion secondary battery of a cylindrical type in which the wound electrode body 20 is contained inside a battery can 11 having a cylindrical shape. The wound electrode body 20 is a battery device.

For example, the secondary battery includes a pair of insulating plates 12 and 13 and the wound electrode body 20 that are provided inside the battery can 11. The wound electrode body 20 is an electrode body resulting from winding a positive electrode 21 and a negative electrode 22 that are stacked on each other with a separator 23 interposed therebetween. The wound electrode body 20 is impregnated with an electrolytic solution. The electrolytic solution is a liquid electrolyte.

The battery can 11 includes one or more of materials including, without limitation, iron (Fe), aluminum (Al), and an alloy thereof. The battery can 11 has a hollow structure with a closed end and an open end. The battery can 11 has a surface that may be coated with nickel (Ni) plating, for example. The insulating plates 12 and 13 each extend in a direction intersecting a wound peripheral surface of the wound electrode body 20. The insulating plates 12 and 13 are disposed to be opposed to each other, sandwiching the wound electrode body 20 therebetween.

A cover member 14, a safety valve mechanism 15, and a thermosensitive resistive device (a PTC device) 16 are crimped at the open end of the battery can 11 via a gasket 17. The open end of the battery can 11 is thereby sealed. The gasket 17 includes an insulating material. The gasket 17 may have a surface coated with a material such as asphalt.

The cover member 14 includes stainless steel having a surface coated with nickel (Ni) plating. A configuration of the cover member 14 will be described in detail later.

The safety valve mechanism 15 and the thermosensitive resistive device 16 are disposed on an inner side of the cover member 14. The safety valve mechanism 15 is electrically coupled to the cover member 14 via the thermosensitive resistive device 16. When an internal pressure of the battery can 11 reaches a certain level or higher due to any cause such as an internal short circuit or heating from outside, the safety valve mechanism 15 causes a disk plate 15A to invert, thereby cutting off electrical coupling between the cover member 14 and the wound electrode body 20. The thermosensitive resistive device 16 is a device having a resistance that increases with a rise in temperature. The thermosensitive resistive device 16 is provided in order to prevent abnormal heat generation resulting from a large current.

A center pin 24 is disposed in a space provided at a winding center of the wound electrode body 20. Note that the center pin 24 may be omitted in some cases. A positive electrode lead 25 is coupled to the positive electrode 21. The positive electrode lead 25 includes one or more of electrically conductive materials including, without limitation, aluminum. The positive electrode lead 25 is electrically coupled to the cover member 14 via the safety valve mechanism 15. A negative electrode lead 26 is coupled to the negative electrode 22. The negative electrode lead 26 includes one or more of electrically conductive materials including, without limitation, nickel. The negative electrode lead 26 is electrically coupled to the battery can 11.

As illustrated in FIG. 2, the positive electrode 21 includes a positive electrode current collector 21A, and two positive electrode active material layers 21B provided on respective opposite sides of the positive electrode current collector 21A. However, the positive electrode active material layer 21B may be provided only on one of the opposite sides of the positive electrode current collector 21A.

The positive electrode current collector 21A includes one or more of electrically conductive materials including, without limitation, aluminum, nickel, and stainless steel. The positive electrode current collector 21A may have a single-layer structure or a multilayer structure.

The positive electrode active material layer 21B includes one or more of positive electrode active materials into which lithium is insertable and from which lithium is extractable. The positive electrode active material may be a lithium-containing compound such as a lithium-containing composite oxide or a lithium-containing phosphoric acid compound. The lithium-containing composite oxide is an oxide that includes, as constituent elements, lithium and one or more of other elements. The lithium-containing composite oxide is an oxide that has any of crystal structures including, without limitation, a layered rock-salt crystal structure and a spinel crystal structure. The lithium-containing phosphoric acid compound is a phosphoric acid compound that includes, as constituent elements, lithium and one or more of the other elements. The lithium-containing phosphoric acid compound is a compound that has a crystal structure such as an olivine crystal structure. The one or more of other elements described above are one or more of any elements other than lithium. The other elements are preferably those belong to groups 2 to 15 in the long periodic table of elements. The other elements are more preferably one or more of elements including, without limitation, nickel (Ni), cobalt (Co), manganese (Mn), and iron (Fe). Use of the lithium-containing compound including these other elements as the positive electrode active material enables the battery device to generate a higher voltage.

Other than the above, the positive electrode active material may be: an oxide such as titanium oxide, vanadium oxide, or manganese dioxide; a disulfide such as titanium disulfide or molybdenum sulfide; a chalcogenide such as niobium selenide; or an electrically conductive polymer such as sulfur, polyaniline, or polythiophene.

The positive electrode active material layer 21B may further include a binder, a conductor, or both. The binder may include one or more of materials including: a synthetic rubber such as a styrene-butadiene-based rubber, a fluorine-based rubber, or an ethylene propylene diene synthetic rubber; and a polymer compound such as polyvinylidene difluoride or polyimide. The conductor may include one or more of carbon materials including, without limitation, graphite, carbon black, acetylene black, and Ketjen black. The conductor may include a material such as a metal material or an electrically conductive polymer.

The negative electrode 22 includes a negative electrode current collector 22A, and a negative electrode active material layer 22B provided on each of opposite sides of the negative electrode current collector 22A or on one of the opposite sides of the negative electrode current collector 22A.

The negative electrode current collector 22A includes one or more of electrically conductive materials including, without limitation, copper, aluminum, nickel, and stainless steel. The negative electrode current collector 22A may have a single-layer structure or a multilayer structure.

The negative electrode current collector 22A may have a surface roughened by a method such as an electrolysis method. In such a case, it is possible to improve the negative electrode current collector 22A in adherence to the negative electrode active material layer 22B by utilizing a so-called anchor effect.

In order to prevent unintentional precipitation of a lithium metal on a surface of the negative electrode 22 during charging, a chargeable capacity of the negative electrode active material is preferably greater than a discharge capacity of the positive electrode 21. In other words, an electrochemical equivalent of the negative electrode active material is preferably greater than an electrochemical equivalent of the positive electrode 21.

The negative electrode active material layer 22B includes one or more of negative electrode active materials into which lithium is insertable and from which lithium is extractable. The negative electrode active material may be a carbon material, a metal-based material, or a mixture of a carbon material and a metal-based material.

The carbon material is a material including carbon as a constituent element. Examples of the carbon material include graphitizable carbon, non-graphitizable carbon, and graphite. Specific examples of the carbon material include pyrolytic carbons, cokes, glassy carbon fibers, an organic polymer compound fired body, activated carbon, carbon blacks, low crystalline carbon, and amorphous carbon. Examples of a shape of the carbon material include a fibrous shape, a spherical shape, a granular shape, and a flaky shape. The carbon material makes it possible to stably achieve a high energy density because the crystal structure of the carbon material hardly changes upon insertion and extraction of lithium. In addition, the carbon material makes it possible to improve electrical conductivity of the negative electrode active material layer 22B because the carbon material also serves as a negative electrode conductor.

The metal-based material is a material including, as one or more constituent elements, any one or more of metal elements or metalloid elements. The metal-based material may be a simple substance, an alloy, or a compound, and may be a mixture of two or more of these. The metal-based material may include, in addition to a material including two or more metal elements, a material including one or more of metal elements and one or more of metalloid elements. Further, the metal-based material may include one or more of non-metallic elements as one or more constituent elements. The metal-based material has a state such as a solid solution, a eutectic (a eutectic mixture), an intermetallic compound, or a state including two or more thereof that coexist.

The metal element or the metalloid element included in the metal-based material is an element that is able to form an alloy with lithium. Examples of the metal element or the metalloid element included in the metal-based material include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt).

The metal-based material is preferably silicon or tin, more preferably silicon. Silicon and tin have superior lithium insertion capacity and superior lithium extraction capacity, and therefore allows the negative electrode 22 to have a markedly high energy density. The metal-based material may be a simple substance of silicon, a silicon alloy, a silicon compound, a simple substance of tin, a tin alloy, a tin compound, a mixture of two or more thereof, or a material including one or more phases thereof.

The negative electrode active material preferably includes both the carbon material and the metal-based material for the following reason. For example, the metal-based material, in particular, a material including silicon or tin as a constituent element is high in theoretical capacity, but easily expands and contracts drastically upon charging and discharging. In contrast, the carbon material is low in theoretical capacity, but does not easily expand or contract upon charging and discharging. Accordingly, a combined use of the carbon material and the metal-based material as the negative electrode active material makes it possible to achieve a high theoretical capacity (i.e., a high battery capacity) and to suppress expansion and contraction of the negative electrode active material layer 22B upon charging and discharging.

The negative electrode active material layer 22B may further include a binder, a conductor, or both. The binder may include one or more of materials including: a synthetic rubber such as a styrene-butadiene-based rubber, a fluorine-based rubber, or an ethylene propylene diene synthetic rubber; and a polymer compound such as polyvinylidene difluoride or polyimide. The conductor may include one or more of carbon materials including, without limitation, graphite, carbon black, acetylene black, and Ketjen black. The conductor may include a material such as a metal material or an electrically conductive polymer.

The separator 23 is a porous film interposed between the positive electrode 21 and the negative electrode 22. The separator 23 allows lithium ions to pass therethrough and prevents a short circuit due to contact between the positive electrode 21 and the negative electrode 22. The separator 23 may include, without limitation, a synthetic resin such as polytetrafluoroethylene, polypropylene, or polyethylene, or ceramics. The separator 23 may be a single-layer film, or may be a multilayer film in which two or more porous films are stacked.

A polymer compound layer may be further provided on one of opposite sides of the separator 23 or on each of the opposite sides of the separator 23. The polymer compound layer is able to improve adherence of each of the positive electrode 21 and the negative electrode 22 to the separator 23, thus allowing the wound electrode body 20 to further resist being distorted. Allowing the wound electrode body 20 to resist being distorted suppresses a decomposition reaction of the electrolytic solution and also suppresses leakage of the electrolytic solution with which a base layer is impregnated. Accordingly, the secondary battery makes it possible to suppress an increase in resistance and suppress swelling upon repeated charging and discharging. The polymer compound layer may include one or more of polymer compounds (such as polyvinylidene difluoride) each having high physical strength and high chemical stability. Further, the polymer compound layer may include one or more kinds of inorganic particles of materials including, without limitation, aluminum oxide and aluminum nitride, to improve safety.

The electrolytic solution includes a solvent and an electrolyte salt. The wound electrode body 20 in which the positive electrode 21 and the negative electrode 22 are wound is impregnated with the electrolytic solution.

The solvent includes one or more of non-aqueous solvents including, without limitation, an organic solvent. The non-aqueous solvent includes one or more of a carbonic acid ester, a chain carboxylic acid ester, a lactone, or a nitrile compound. The carbonic acid ester includes both a cyclic carbonic acid ester and a chain carbonic acid ester. Examples of the cyclic carbonic acid ester include ethylene carbonate, propylene carbonate, and butylene carbonate. Examples of the chain carbonic acid ester include dimethyl carbonate, diethyl carbonate, ethylmethyl carbonate, and methylpropyl carbonate. Examples of the chain carboxylic acid ester include methyl acetate, ethyl acetate, methyl propionate, ethyl propionate, propyl propionate, methyl butyrate, methyl isobutyrate, methyl trimethylacetate, and ethyl trimethylacetate. Examples of the lactone include γ-butyrolactone and γ-valerolactone. Examples of the nitrile compound include acetonitrile, methoxy acetonitrile, and 3-methoxy propionitrile.

Other than the above, examples of the solvent may further include 1,2-dimethoxy ethane, tetrahydrofuran, 2-methyl tetrahydrofuran, tetrahydropyran, 1,3-dioxolane, 4-methyl-1,3-dioxolane, 1,4-dioxane, N,N-dimethyl formamide, N-methyl pyrrolidinone, N-methyl oxazolidinone, N,N′-dimethyl imidazolidinone, nitromethane, nitroethane, sulfolane, trimethyl phosphate, and dimethyl sulfoxide.

In particular, in order to achieve characteristics including, without limitation, a further superior battery capacity, a further superior cyclability characteristic, and a further superior storage characteristic, the solvent preferably includes one or more of carbonic acid esters including, without limitation, ethylene carbonate, propylene carbonate, dimethyl carbonate, diethyl carbonate, and ethyl methyl carbonate.

For example, the solvent more preferably includes a combination of: the cyclic carbonic acid ester which is a solvent having a high viscosity or a high dielectric constant (specific dielectric constant ε≥30); and the chain carbonic acid ester which is a solvent having a low viscosity (viscosity≤1 mPa·s). Examples of such a cyclic carbonic acid ester include ethylene carbonate and propylene carbonate. Examples of such a chain carbonic acid ester include dimethyl carbonate, ethyl methyl carbonate, and diethyl carbonate. The solvent thus makes it possible to improve a dissociation property of the electrolyte salt and ion mobility.

The solvent may further include, as one or more additives, any one or more of an unsaturated cyclic carbonic acid ester, a halogenated carbonic acid ester, a sulfonic acid ester, an acid anhydride, a dinitrile compound, a diisocyanate compound, or a phosphoric acid ester. This allows the solvent to improve chemical stability of the electrolytic solution.

The electrolyte salt includes one or more of salts including, without limitation, a lithium salt. However, the electrolyte salt may include a salt such as a light metal salt other than the lithium salt. Examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr).

In particular, the electrolyte salt preferably includes one or more of lithium hexafluorophosphate, lithium tetrafluoroborate, lithium perchlorate, or lithium hexafluoroarsenate, and more preferably includes lithium hexafluorophosphate. In such a case, the electrolyte salt is able to decrease internal resistance, thus making it possible to further improve a battery characteristic of the secondary battery.

A content of the electrolyte salt is not particularly limited. However, in order to achieve high ionic conductivity, the content of the electrolyte salt is preferably within a range from 0.3 mol/kg to 3.0 mol/kg both inclusive with respect to the solvent.

Note that the respective materials of the positive electrode, the negative electrode, the separator, and the electrolytic solution are not limited to the examples described above, and other materials are also employable.

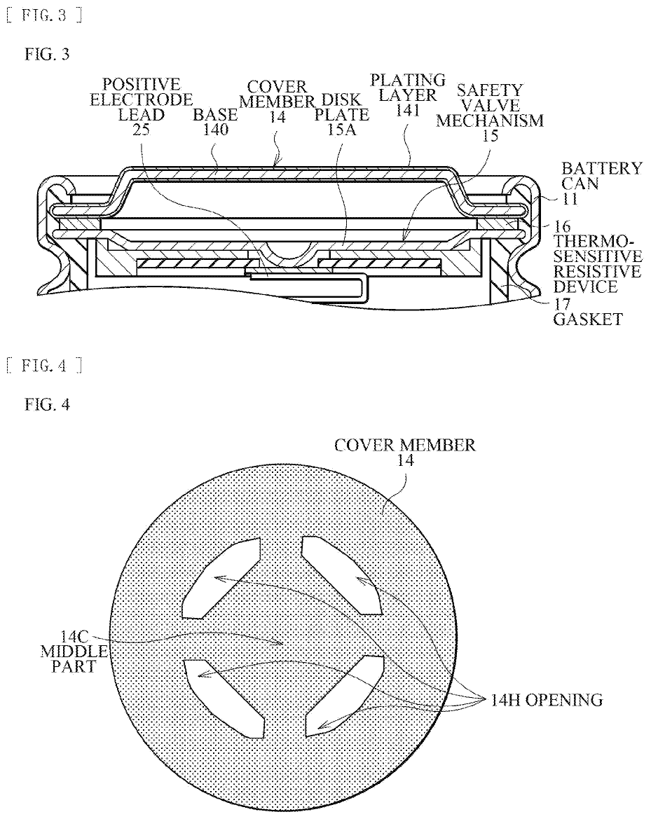

Next, referring to FIGS. 3 to 5, a more detailed description is given of the cover member 14 included in the secondary battery according to an embodiment. FIG. 3 is an enlarged sectional view of the vicinity of the cover member 14 in FIG. 1. FIG. 4 is a top view of a planar configuration of the cover member 14. FIG. 5 is a schematic sectional view of a crystal structure of a plating layer 141 included in the cover member 14.

As illustrated in FIGS. 3 and 4, the cover member 14 included in the secondary battery according to an embodiment includes a base 140 including stainless steel, and the plating layer 141 including nickel plating.

The base 140 is a member that defines a shape of the cover member 14, and has a circular planar shape. The base 140 has a middle part 14C around which openings 14H are provided in point symmetry. The middle part 14C is convex toward an opposite side to the battery can 11.

The plating layer 141 covers a surface of the base 140. The plating layer 141 is provided on the entire surface including two major surfaces and an end face of the base 140. For example, the plating layer 141 is provided on the entire surface of the circular planar shape of the base 140, including the two major surfaces, the end face, and inner end faces of the openings 14H. This plating layer 141 may be formed by forming, for example, the openings 14H on the base 140, performing shape processing on the base 140, and thereafter immersing the entire base 140 in a plating solution in an electroplating bath. Although not particularly limited in composition, the plating solution includes, for example, 450 g/l (=450 g/dm³) of nickel sulfamate, 30 g/l (=30 g/dm³) of boric acid, and less than or equal to 8 mg/l (=8 mg/dm³) of sulfur (S). Nickel sulfamate has higher solubility than solubility of nickel sulfate. Using nickel sulfamate thus makes it possible to obtain a plating solution or a plating bath with a high content of a nickel component.

In the secondary battery, in a case where excessive charging and discharging reactions result in battery combustion, gas can be generated inside the battery. In such a case, to exhaust the gas generated inside the battery, the sealing of the battery can 11 on the cover member 14 side is broken in the secondary battery, and the gas generated inside the battery is exhausted via the openings 14H of the cover member 14.

In recent years, an amount of gas generated upon battery combustion has increased with improvement in performance of secondary batteries. In view of this, in the cover member 14, increasing an area of the openings 14H and including the stainless steel with higher strength in the base 140 makes it possible to exhaust the gas inside the battery more efficiently upon battery combustion, while keeping strength of the cover member 14.

For example, the base 140 of the cover member 14 includes the stainless steel. This allows the secondary battery to exhibit a further superior result in a drop test (a drop test in accordance with JIS C 8712), as demonstrated in Examples to be described later. In other words, in the secondary battery in which the base 140 includes the stainless steel, it is possible to further suppress leakage of the electrolytic solution upon a drop, which makes it possible to further increase a passing rate in the drop test described above.

In addition, it is preferable that the openings 14H be provided in an area of greater than or equal to 9% and less than or equal to 12% with respect to a sectional area of an internal space of the secondary battery defined by the battery can 11 and the cover member 14. In such a case, the secondary battery is able to exhibit a further superior result in a combustion test (a UL Standard 1642 projectile test), as demonstrated in Examples to be described later. In other words, the secondary battery having the openings 14H with an area proportion within the above-described range makes it possible to further increase a passing rate in the combustion test described above.

For example, the area proportion of the openings 14H is more preferably greater than or equal to 9% with respect to the sectional area of the internal space of the secondary battery, because this results in suitable gas exhaustibility from the openings 14H. In addition, the area proportion of the openings 14H is preferably less than or equal to 12% with respect to the sectional area of the internal space of the secondary battery, because this makes it possible to improve the strength of the cover member 14 enough to markedly suppress leakage of the electrolytic solution in the drop test.

In the cover member 14, the entire surface of the base 140 including the stainless steel with a relatively high electric resistance value is covered with the plating layer 141 including the nickel plating with a low electric resistance value. This allows the cover member 14 to keep a lower electric resistance value between the two major surfaces by means of the plating layer 141 provided on the end face. As a result, the cover member 14 is able to transmit a current extracted from the positive electrode 21 of the wound electrode body 20 to the outside of the secondary battery with lower resistance.

Further, in the secondary battery according to an embodiment, the plating layer 141 has a crystal structure including columnar crystals in a proportion of greater than or equal to 80%.

The columnar crystals represent a crystal structure vertically grown in a thickness direction of the nickel plating. This crystal structure tends to be generated when the nickel plating is formed with a small current value over a long time. The plating layer 141 including a large number of columnar crystals includes a small number of grain boundaries with trapped impurities, which helps to prevent a decrease in peel strength at the grain boundary resulting from heat and applied pressure in welding. As a result, the plating layer 141 including a large number of columnar crystals makes it possible to further increase a peel strength, and to further increase a joint strength achieved by welding.

In contrast, in a case where the nickel plating is formed using a large current in a short time, the nickel plating includes a large number of granular crystals finer than columnar crystals. The plating layer 141 including a large number of granular crystals includes a large number of grain boundaries with trapped impurities, which easily causes a decrease in peel strength at the grain boundary resulting from heat and applied pressure in welding. The plating layer 141 including a large number of granular crystals thus tends to result in a low peel strength of the plating layer 141, and a low joint strength achieved by welding.

In the secondary battery according to an embodiment, columnar crystals are included in a proportion of greater than or equal to 80% in the plating layer 141 of the cover member 14. This makes it possible to further increase the peel strength of the plating layer 141, and to further increase the joint strength achieved by joining to the cover member 14.

As illustrated in FIG. 5, the plating layer 141 includes an underlayer 141A provided on the base 140, and a main layer 141B provided on the underlayer 141A.

The underlayer 141A is a layer provided on the surface of the base 140 including the stainless steel, and mainly including granular crystals. The underlayer 141A is formed as a thin film after an oxide film on the surface of the base 140 including the stainless steel is removed.

The main layer 141B is a layer provided on the underlayer 141A and mainly including columnar crystals. The main layer 141B occupies a large proportion of the plating layer 141. The main layer 141B is provided on the underlayer 141A and is thicker than the underlayer 141A.

A boundary between the underlayer 141A and the main layer 141B may be at a thickness position beyond which columnar crystals are included. In other words, the underlayer 141A may represent a layer including only granular crystals in the plating layer 141, and the main layer 141B may represent a layer at least partially including columnar crystals in the plating layer 141.

In the plating layer 141, it is preferable that the underlayer 141A have a thickness of greater than or equal to 0.2 μm and less than or equal to 0.8 μm, and the main layer 141B have a thickness of greater than or equal to 2.1 μm and less than or equal to 4.0 μm. In such a case, the plating layer 141 obtains a suitable balance between the underlayer 141A mainly including granular crystals and the main layer 141B mainly including columnar crystals. This makes it possible to increase the peel strength of the plating layer 141, and to further increase the joint strength achieved by welding to the cover member 14.

It is not preferable that the thickness of the underlayer 141A be less than 0.2 μm, because this leads to an excessively low peel strength between the underlayer 141A and the main layer 141B. It is not preferable that the thickness of the underlayer 141A be greater than 0.8 μm, because this leads to an excessively high peel strength between the underlayer 141A and the main layer 141B, which makes melting and welding difficult between the plating layer 141 and another member. In addition, it is not preferable that the thickness of the main layer 141B be less than 2.1 μm, because this makes the main layer 141B excessively soft, and leads to an excessively low peel strength. It is not preferable that the thickness of the main layer 141B be greater than 4.0 μm, because this makes the main layer 141B excessively hard, which makes melting and welding difficult between the plating layer 141 and another member.

Note that, as illustrated in FIG. 5, in a case where a total thickness of the plating layer 141 is denoted by “t”, the columnar crystal in the crystal structure of the plating layer 141 may represent a crystal whose crystal height T in the thickness direction of the plating layer 141 is greater than or equal to ⅓t, and whose crystal width W in an in-plane direction of the plating layer 141 is greater than or equal to 1/10t. The granular crystal may represent a crystal that does not satisfy the above-described condition for the columnar crystal.

In other words, in the secondary battery according to an embodiment, the plating layer 141 includes columnar crystals in a proportion of greater than or equal to 80% in an entire section of the plating layer 141 including the underlayer 141A and the main layer 141B. For example, in the secondary battery according to an embodiment, the plating layer 141 may include columnar crystals in an area proportion of greater than or equal to 80% in a rectangular section represented by a product of the total thickness “t” of the plating layer 141 and a width “w” (=3t) in the in-plane direction of the plating layer 141.

The secondary battery according to an embodiment is able to perform a charging and discharging operation in the following manner.

Upon charging, the secondary battery allows lithium ions to be extracted from the positive electrode 21 and allows the extracted lithium ions to be inserted into the negative electrode 22 via the electrolytic solution. In contrast, upon discharging, the secondary battery allows lithium ions to be extracted from the negative electrode 22 and allows the extracted lithium ions to be inserted into the positive electrode 21 via the electrolytic solution. In other words, the secondary battery allows charging and discharging to be performed by lithium ions moving between the positive electrode 21 and the negative electrode 22 via the electrolytic solution.

The secondary battery according to an embodiment is manufacturable by the following procedure. After fabrication of the positive electrode 21 and fabrication of the negative electrode 22 are performed, assembly of the lithium-ion secondary battery is performed.

First, the positive electrode active material is mixed with materials including, without limitation, the positive electrode binder and the positive electrode conductor on an as-needed basis to thereby prepare a positive electrode mixture. Thereafter, the positive electrode mixture is dispersed or dissolved in a solvent such as an organic solvent to thereby prepare a paste positive electrode mixture slurry. Thereafter, the positive electrode mixture slurry is applied on opposite sides of the positive electrode current collector 21A, following which the applied positive electrode mixture slurry is dried to thereby form the positive electrode active material layers 21B. The positive electrode active material layers 21B may be compression-molded by means of a machine such as a roll pressing machine. In such a case, the positive electrode active material layers 21B may be heated. The positive electrode active material layers 21B may be compression-molded multiple times.

The negative electrode 22 is fabricable by a procedure similar to the fabrication procedure of the positive electrode 21 described above.

The negative electrode active material is mixed with materials including, without limitation, the negative positive electrode binder and the negative electrode conductor on an as-needed basis to thereby prepare a negative electrode mixture. Thereafter, the negative electrode mixture is dispersed or dissolved in a solvent such as an organic solvent to thereby prepare a paste negative electrode mixture slurry. Thereafter, the negative electrode mixture slurry is applied on opposite sides of the negative electrode current collector 22A, following which the applied negative electrode mixture slurry is dried to thereby form the negative electrode active material layers 22B. The negative electrode active material layers 22B may be compression-molded.

The positive electrode lead 25 is coupled to the positive electrode current collector 21A by a method such as a welding method, and the negative electrode lead 26 is similarly coupled to the negative electrode current collector 22A by a method such as a welding method. Thereafter, the positive electrode 21 and the negative electrode 22 are stacked on each other with the separator 23 interposed therebetween, following which the positive electrode 21, the negative electrode 22, and the separator 23 are wound to thereby form a wound body. Thereafter, the center pin 24 is placed into the space provided at the winding center of the wound body.

Thereafter, the wound body is interposed between the pair of insulating plates 12 and 13, and the wound body in that state is contained inside the battery can 11 together with the insulating plates 12 and 13. In this case, the positive electrode lead 25 is coupled to the safety valve mechanism 15 by a method such as a welding method, and the negative electrode lead 26 is coupled to the battery can 11 by a method such as a welding method. Thereafter, the electrolytic solution is injected into the battery can 11 to thereby impregnate the wound body with the electrolytic solution. Thus, the positive electrode 21, the negative electrode 22, and the separator 23 are each impregnated with the electrolytic solution. As a result, the wound electrode body 20 is formed.

Thereafter, the open end of the battery can 11 is crimped via the gasket 17 to thereby attach the cover member 14, the safety valve mechanism 15, and the thermosensitive resistive device 16 to the open end of the battery can 11. Thus, the wound electrode body 20 is sealed in the battery can 11. As a result, the secondary battery is completed.

In the secondary battery according to an embodiment, the cover member 14 includes the stainless steel (the base 140) coated with the nickel plating (the plating layer 141) including, in the crystal structure, columnar crystals in a proportion of greater than or equal to 80%. Thus, in the secondary battery, it is possible to further increase the peel strength of the plating layer 141, and to further increase the joint strength achieved by welding to the cover member 14. In addition, in the secondary battery, the base 140 of the cover member 14 includes the stainless steel with high strength. This makes it possible to further suppress leakage of the electrolytic solution upon a drop. As a result, the secondary battery according to an embodiment is able to achieve improved reliability.

In the secondary battery, it is preferable that the plating layer 141 include the underlayer 141A having a thickness of greater than or equal to 0.2 μm and less than or equal to 0.8 μm, and the main layer 141B having a thickness of greater than or equal to 2.1 μm and less than or equal to 4.0 μm. In such a case, in the secondary battery, it is possible to increase the peel strength of the plating layer 141, and to further increase the joint strength achieved by welding to the cover member 14. This makes it possible to improve the reliability.

In the secondary battery, the area proportion of the openings 14H provided in the cover member 14 is preferably greater than or equal to 9% and less than or equal to 12% with respect to the sectional area of the internal space of the secondary battery defined by the battery can 11 and the cover member 14. In such a case, the secondary battery is able to achieve both the gas exhaustibility from the openings 14H and the strength of the cover member 14. This makes it possible to further improve the reliability.

Further, in the secondary battery, the plating layer 141 including the nickel plating may be provided on the entire surface including the end face of the base 140. In such a case, in the secondary battery, it is possible to further increase electrical conductivity between the two major surfaces of the cover member 14, which makes it possible to extract a current from the battery device with lower resistance.

Next, a description is given of modifications of the secondary battery according to an embodiment. The configuration of the secondary battery is appropriately modifiable as described herein. Note that any two or more of the following series of modifications may be combined with each other.

In an embodiment described herein, the separator 23 is a porous film. However, the separator 23 may be a stacked film including a polymer compound layer.

For example, the separator 23 may include a base layer that is the porous film described above and the polymer compound layer provided on one of opposite sides of the base layer or on each of the opposite sides of the base layer. The polymer compound layer includes a polymer compound that has superior physical strength and is electrochemically stable, such as polyvinylidene difluoride. Thus, it is possible to improve adherence of the separator 23 to each of the positive electrode 21 and the negative electrode 22 and to thereby suppress displacement inside the wound electrode body 20. Accordingly, it is possible to suppress occurrence of swelling of the secondary battery even if, for example, a decomposition reaction of the electrolytic solution occurs.

Note that the base layer, the polymer compound layer, or both in the separator 23 may each include particles. The particles may include one or more kinds of particles among, for example, inorganic particles and resin particles. It is thus possible to dissipate heat by means of the particles upon heat generation by the secondary battery. Accordingly, it is possible to improve heat resistance and safety of the secondary battery. Although not particularly limited, examples of the inorganic particles may include particles of: aluminum oxide (alumina), aluminum nitride, boehmite, silicon oxide (silica), titanium oxide (titania), magnesium oxide (magnesia), and zirconium oxide (zirconia).

Note that the separator 23 that is the stacked film including the polymer compound layer may be fabricated by preparing a precursor solution including, for example, the polymer compound and an organic solvent and thereafter applying the precursor solution on one of the opposite sides of the base layer or on each of the opposite sides of the base layer.

In a case where this separator 23 is used also, lithium is movable between the positive electrode 21 and the negative electrode 22, and similar effects of the secondary battery are thus obtainable.

In an embodiment described herein, the wound electrode body 20 has a device structure of the stacked type in which the positive electrode 21 having a sheet shape, the negative electrode 22 having a sheet shape, and the separator 23 are stacked on each other. However, the device structure of the wound electrode body 20 is not limited to that in an embodiment described above. The device structure of the wound electrode body 20 may be of a zigzag folded type in which the positive electrode 21, the negative electrode 22, and the separator 23 are folded in a zigzag manner, or of a stack-and-folding type.

Applications (application examples) of the secondary battery are not particularly limited. The secondary battery used as a power source may be used as a main power source or an auxiliary power source of, for example, electronic equipment and electric vehicles. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use, for accumulation of electric power for a situation such as emergency. In such applications, a single secondary battery may be used, or multiple secondary batteries may be used.

The battery pack may include a single battery, or may include an assembled battery. The electric vehicle is a vehicle that operates (travels) using the secondary battery as a driving power source, and may be a hybrid automobile that is additionally provided with a driving source other than the secondary battery. The electric power storage system for home use allows for utilization of electric power accumulated in the secondary battery which is an electric power storage source to cause, for example, home appliances to operate.

An application example of the secondary battery will now be described in detail. The configuration of the application example described below is merely an example, and is appropriately modifiable.

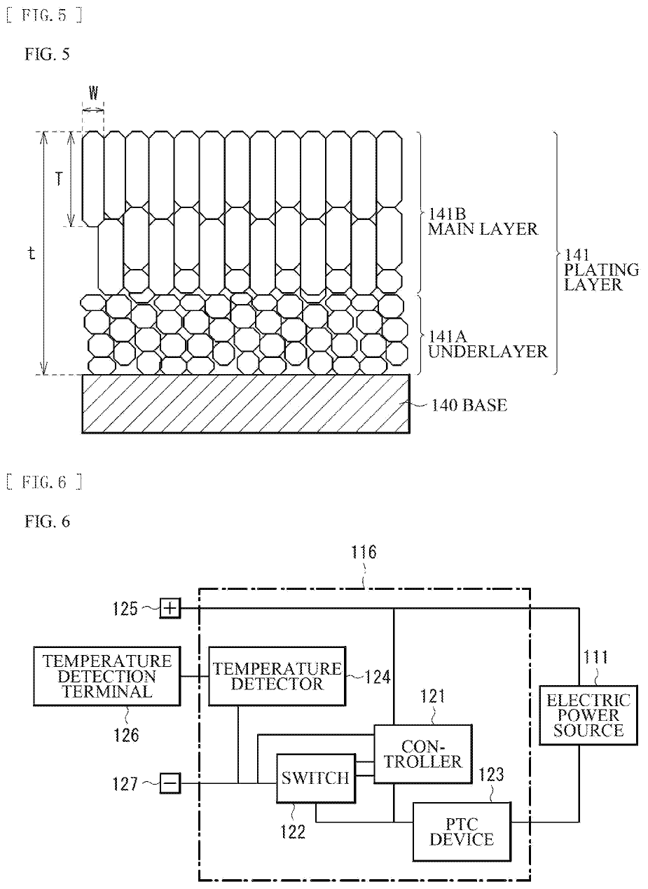

FIG. 6 illustrates a block configuration of a battery pack. The battery pack described here is a battery pack (a so-called soft pack) including one secondary battery, and is to be mounted on, for example, electronic equipment typified by a smartphone.

As illustrated in FIG. 6, the battery pack includes an electric power source 111 and a circuit board 116. The circuit board 116 is coupled to the electric power source 111, and includes a positive electrode terminal 125, a negative electrode terminal 127, and a temperature detection terminal 126.

The electric power source 111 includes one secondary battery. The secondary battery has a positive electrode coupled to the positive electrode terminal 125 and a negative electrode coupled to the negative electrode terminal 127. The electric power source 111 is couplable to outside via the positive electrode terminal 125 and the negative electrode terminal 127, and is thus chargeable and dischargeable via the positive electrode terminal 125 and the negative electrode terminal 127. The circuit board 116 includes a controller 121, a switch 122, a PTC device 123, and a temperature detector 124. However, the PTC device 123 may be omitted.

The controller 121 includes, for example, a central processing unit (CPU) and a memory, and controls an overall operation of the battery pack. The controller 121 detects and controls a use state of the electric power source 111 on an as-needed basis.

If a voltage of the electric power source 111 (the secondary battery) reaches an overcharge detection voltage or an overdischarge detection voltage, the controller 121 turns off the switch 122. This makes it possible to prevent a charging current from flowing into a current path of the electric power source 111. The overcharge detection voltage and the overdischarge detection voltage are not particularly limited. For example, the overcharge detection voltage is 4.2 V±0.05 V and the overdischarge detection voltage is 2.4 V±0.1 V.

The switch 122 includes, for example, a charge control switch, a discharge control switch, a charging diode, and a discharging diode. The switch 122 performs switching between coupling and decoupling between the electric power source 111 and external equipment in accordance with an instruction from the controller 121. The switch 122 includes, for example, a metal-oxide-semiconductor field-effect transistor (MOSFET). The charging and discharging currents are detected based on an ON-resistance of the switch 122.

The temperature detector 124 includes a temperature detection device such as a thermistor. The temperature detector 124 measures a temperature of the electric power source 111 using the temperature detection terminal 126, and outputs a result of the temperature measurement to the controller 121. The result of the temperature measurement to be obtained by the temperature detector 124 is used, for example, in a case where the controller 121 performs charge/discharge control on the electric power source 111 upon abnormal heat generation or in a case where the controller 121 performs a correction process regarding a remaining capacity of the electric power source 111 upon calculating the remaining capacity.

### EXAMPLES

Referring to Examples and comparative examples, a description is given in more detail below of the secondary battery according to an embodiment. Note that Examples described below are merely examples further describing the secondary battery according to an embodiment. The present technology is therefore not limited to Examples described herein.

### (Manufacture of Secondary Battery)

Secondary batteries according to Examples and comparative examples were manufactured by the following procedure.

First, the positive electrode active material, the positive electrode binder, and the positive electrode conductor were mixed with each other to thereby obtain a positive electrode mixture. Thereafter, the positive electrode mixture was put into an organic solvent to thereby prepare a paste positive electrode mixture slurry. The prepared positive electrode mixture slurry was applied on opposite sides of the positive electrode current collector (an aluminum foil), following which the applied positive electrode mixture slurry was heated and dried to thereby form the positive electrode active material layers. Thereafter, the positive electrode active material layers were compression-molded by means of a roll pressing machine. The positive electrode was thus fabricated.

Thereafter, the negative electrode active material, the negative electrode binder, and the negative electrode conductor were mixed with each other to thereby obtain a negative electrode mixture. Thereafter, the negative electrode mixture was put into an organic solvent to thereby prepare a paste negative electrode mixture slurry. The prepared negative electrode mixture slurry was applied on opposite sides of the negative electrode current collector (a copper foil), following which the applied negative electrode mixture slurry was heated and dried to thereby form the negative electrode active material layers. Thereafter, the negative electrode active material layers were compression-molded by means of a roll pressing machine. The negative electrode was thus fabricated.

Thereafter, the electrolyte salt was put into a solvent and the electrolyte salt was dissolved in the solvent. The electrolytic solution was thus prepared.

Thereafter, the positive electrode lead was coupled to the positive electrode by a method such as a welding method, and the negative electrode lead was similarly coupled to the negative electrode by a method such as a welding method. Thereafter, the positive electrode and the negative electrode were stacked on each other with the separator interposed therebetween, and the positive electrode, the negative electrode, and the separator were wound to thereby form the wound body. The formed wound body was placed inside the battery can having a cylindrical shape and an outer diameter of 26 mm. In this case, the positive electrode lead was coupled to the safety valve mechanism by a method such as a welding method, the negative electrode lead was coupled to the battery can by a method such as a welding method, and the electrolytic solution was injected into the battery can to thereby impregnate the wound body with the electrolytic solution. Thereafter, the open end of the battery can was sealed, by means of the gasket, with the cover member including the stainless steel coated with the nickel plating. The wound body was thus sealed in the battery can. In this manner, the secondary battery was manufactured.

### (Method of Testing Secondary Battery)

The secondary batteries according to Examples and the comparative examples manufactured by the above-described procedure were each subjected to measurement of the proportion of columnar crystals in the plating layer, and to measurement involved in a welding test, a drop test, and a combustion test.

The proportion of columnar crystals in the plating layer was calculated by exposing a section of the plating layer by means of a focused ion beam (FIB) system, and thereafter observing the exposed section of the plating layer by means of a scanning ion microscope (SIM) with a magnification of 30,000 times.

In a case where the total thickness of the plating layer was denoted by “t”, the area proportion of columnar crystals in the section of the plating layer with a width corresponding to 3t in the in-plane direction of the plating layer was calculated. Note that the columnar crystal was assumed to be a crystal whose crystal height in the thickness direction of the plating layer was greater than or equal to ⅓t and whose crystal width in the in-plane direction of the plating layer was greater than or equal to 1/10t, with respect to the total thickness “t” of the plating layer.

The welding test was performed on 32 test samples by the following method. A lead including copper coated with tin plating (having a thickness “t” of 0.15 mm) was welded to the middle part of the cover member by resistance welding to form a welding mark with a diameter of greater than or equal to 1 mm. Thereafter, it was evaluated whether, when the welded lead was peeled with predetermined force from the fixed cover member, a hole (breakage of the material) was made in the lead. In this test, in a case where a hole was made in the lead, it was determined that the lead was favorably welded to the cover member. A result was evaluated based on “number of test samples in which hole was made in lead/total number of test samples”. A larger number of test samples in which the hole was made in the lead indicates a more favorable result of the welding test.

The drop test was performed on 30 test samples in accordance with JIS C 8712. The secondary battery was dropped three times onto a concrete floor from a height of 10 meters with the cover member side facing down, and it was thereafter evaluated whether leakage of the electrolytic solution from the secondary battery occurred. In this test, a case where no leakage of the electrolytic solution from the secondary battery occurred after the drop was determined as “A”, and a case where leakage of the electrolytic solution from the secondary battery occurred at least slightly after the drop was determined as “B”. “A” is more favorable than “B”.

The combustion test was performed on 10 test samples, in accordance with the UL Standard 1642 projectile test. In this test, a case where greater than or equal to 90% of the test samples passed was determined as “A”, and a case where greater than or equal to 10% of the test samples failed was determined as “B”. “A” is more favorable than “B”.

### (Evaluation Results)

First, the secondary batteries according to Examples manufactured by the above-described procedure were subjected to measurement of electric resistance of the cover member by a four-terminal method. The electric resistance between one major surface (a region on an outer side of the openings) of the cover member facing the inside of the secondary battery, and the other major surface (a region in the middle part) of the cover member facing the outside of the secondary battery was measured by the four-terminal method, and an arithmetic mean value of 10 samples was calculated.

As a result, the cover member coated with the nickel plating on the entire surface including the end face had an electric resistance value of 1.55 mΩ, and the cover member coated with the nickel plating only on the two major surfaces excluding the end face had an electric resistance value of 1.74 mΩ. This indicates that, in the cover member coated with the nickel plating on the entire surface including the end face, a current flows via the plating layer covering the surface of the base including the stainless steel, which makes it possible to reduce the electric resistance value, as compared with the cover member coated with the nickel plating discontinuous between the two major surfaces.

Next, Table 1 below presents evaluation results of the welding test performed on each of the secondary batteries according to Examples and the comparative examples manufactured by the above-described procedure.

TABLE 1

| | Thickness | Thickness | Proportion [%] | |
|---|---|---|---|---|
| | [μm] of | [μm] of | of columnar | Welding |
| | underlayer | main layer | crystals | test |
| Example 1 | 0.2 | 2.1 | 80 | 32/32 |
| Example 2 | 0.2 | 2.1 | 95 | 32/32 |
| Example 3 | 0.2 | 4.0 | 80 | 32/32 |
| Example 4 | 0.8 | 2.1 | 80 | 32/32 |
| Example 5 | 0.8 | 4.0 | 80 | 32/32 |
| Example 6 | 0.1 | 2.0 | 80 | 30/32 |
| Example 7 | 0.9 | 2.1 | 80 | 32/32 |
| Example 8 | 0.2 | 5.0 | 80 | 30/32 |
| Comparative | 0.2 | 2.1 | 79 | 28/32 |
| example 1 | | | | |
| Comparative | 0.2 | 2.1 | 80 | 10/32 |
| example 2 | | | | |

As indicated in Table 1, in the secondary batteries according to Examples 1 to 8, because the proportion of columnar crystals in the plating layer was greater than or equal to 80%, favorable results were obtained in the welding test, as compared with the secondary batteries according to Comparative examples 1 and 2. In the secondary batteries according to Examples 1 to 5, because the thicknesses of the underlayer and the main layer in the plating layer were included in the respective suitable ranges described above, further favorable results were obtained in the welding test, as compared with the secondary batteries according to Examples 6 to 8.

Next, Table 2 below presents evaluation results of the drop test and the combustion test performed on each of the secondary batteries according to Examples manufactured by the above-described procedure. Note that, in each of the following secondary batteries according to Examples 10 to 14, the proportion of columnar crystals in the plating layer was 80%.

TABLE 2

| | | | Total | Sectional | | | |
|---|---|---|---|---|---|---|---|
| | Area (A) | | area | area (B) | Ratio | | |
| | [mm²] of | Number of | [mm²] of | [mm²] of | (A/B) | Drop | Combustion |
| | opening | openings | openings | battery | [%] | test | test |
| Example 10 | 16.500 | 4 | 66.000 | 530.7 | 12.4 | B | A |
| Example 11 | 15.900 | 4 | 63.600 | 530.7 | 12.0 | A | A |
| Example 12 | 14.083 | 4 | 56.333 | 530.7 | 10.6 | A | A |
| Example 13 | 12.000 | 4 | 48.000 | 530.7 | 9.0 | A | A |
| Example 14 | 14.786 | 3 | 44.358 | 530.7 | 8.4 | A | B |

As indicated in Table 2, in the secondary batteries according to Examples 10 to 13, because the proportion of the total area of the openings with respect to the sectional area of the secondary battery was greater than or equal to 9%, favorable results were obtained in the drop test, as compared with Example 14. In the secondary batteries according to Examples 11 to 14, because the proportion of the total area of the openings with respect to the sectional area of the secondary battery was less than or equal to 12%, favorable results were obtained in the combustion test, as compared with Example 10. In other words, the results presented in Table 2 indicate that the proportion of the total area of the openings with respect to the sectional area of the secondary battery is preferably greater than or equal to 9% and less than or equal to 12%.

Although the present technology has been described herein with reference to one or more embodiments including Examples, the configuration of the present technology is not limited to those described herein, and is therefore modifiable in a variety of suitable ways.

Although the description has been given herein of the case where the electrode reactant is lithium, the electrode reactant is not particularly limited. For example, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery can having a container-shaped structure and containing a battery device inside; and
a cover member attached to an open surface of the battery can via a gasket, wherein
the cover member includes a stainless steel coated with a nickel plating, and
the nickel plating has a crystal structure in which a proportion of columnar crystals is greater than or equal to 80 percent.

2. The secondary battery according to claim 1, wherein the nickel plating coats an entire surface including an end face of the stainless steel.

3. The secondary battery according to claim 1, wherein the nickel plating includes an underlayer provided on the stainless steel and having a thickness of greater than or equal to 0.2 micrometers and less than or equal to 0.8 micrometers, and a main layer provided on the underlayer and having a thickness of greater than or equal to 2.1 micrometers and less than or equal to 4.0 micrometers.

4. The secondary battery according to claim 1, wherein
the cover member has an opening, and
a proportion of an opening area of the opening is greater than or equal to 9 percent and less than or equal to 12 percent, with respect to a sectional area of an internal space defined by the battery can and the cover member.

5. The secondary battery according to claim 1, wherein the columnar crystals comprise crystals each having, in a section of the nickel plating, a crystal height of greater than or equal to one-third a thickness of the nickel plating in a thickness direction of the nickel plating, and a crystal width of greater than or equal to one-tenth the thickness of the nickel plating in an in-plane direction of the nickel plating.

6. The secondary battery according to claim 1, wherein the battery can has a cylindrical shape.

7. The secondary battery according to claim 1, wherein the secondary battery comprises a lithium-ion secondary battery.
